(19) United States
(12) Patent Application Publication
(10) Pub. No.: US 2010/0204062 A1
(43) Pub. Date: Aug. 12, 2010

(54) CALIBRATION METHODS FOR MULTIPLEXED SENSOR ARRAYS

(75) Inventors: Mark Thompson, Anaheim, CA (US); Richard Roberts, South Pasadena, CA (US); Richard Cote, Miami, FL (US); Chongwu Zhou, Rowland Heights, CA (US)

Correspondence Address: DAVIS WRIGHT TREMAINE LLP/Los Angeles, 865 FIGUEROA STREET, SUITE 2400, LOS ANGELES, CA, 90017-2566, US

(73) Assignee: UNIVERSITY OF SOUTHERN CALIFORNIA, Los Angeles, CA (US)

(21) Appl. No.: 12/614,239

(22) Filed: Nov. 6, 2009

Related U.S. Application Data
(60) Provisional application No. 61/112,287, filed on Nov. 7, 2008.

(51) Int. Cl. C40B 40/06; C40B 40/10; G01N 35/00

(52) U.S. Cl. 506/16; 506/18; 73/1.02

(57) ABSTRACT

The present invention relates to the calibration of devices using a secondary binding agent or reference material. In one embodiment, the present invention provides a method of calibrating a nanosensor by providing a nanosensor comprising an analyte binder attached to a reference binder, extracting a calibration curve from binding a reference material to the reference binder, and calibrating the nanosensor by using the calibration curve to correct for device variation.

### CROSS-REFERENCE TO RELATED APPLICATIONS

The present application claims the benefit of priority under 35 U.S.C. §119(e) of provisional application Ser. No. 61/112,287, filed Nov. 7, 2008, the contents of which are hereby incorporated by reference.

### GOVERNMENT RIGHTS

This invention was made with U.S. Government support on behalf of the National Institutes of Health by NIH-RO1 grant EB-008275. The U.S. Government may have certain rights in this invention.

### FIELD OF THE INVENTION

This invention relates generally to the fields of nanosensors and multiplexed arrays and, more specifically, to calibration of nanosensor devices.

### BACKGROUND OF THE INVENTION

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Nanosensors such as nanowire based field effect transistors (FETs) are very promising devices with potential applications ranging from health monitoring to drug discovery. These sensor devices have also been used to monitor enzymatic activities and to study the behavior of potential drug molecules. These devices have demonstrated the ability to detect a variety of analytes such as particular DNA sequences, cancer biomarkers, and larger entities such as viruses, with the detection of the analytes often occurring with high specificity and sensitivity in reasonably short time. Additionally, the array of FETs may be converted into a multiplexed array of bionansensors, where several biomolecules may be detected simultaneously. However, there is inevitably some device to device variation in performance due in part to random orientation of nanowires over the surface of the nanosensor. Additionally, in constructing a multiplexed array of biosensors for example, analyte binding groups are anchored to the nanowire surface. Variable numbers of such binding groups between different devices in the array will cause a divergence in the properties of the devices within the array. The sensing ability of the different sensors is expected to vary across the array. Thus, there exists a need in the art for novel and effective calibration techniques for sensor arrays.

### SUMMARY OF THE INVENTION

Various embodiments include a method of calibrating a nanosensor comprising providing a nanosensor comprising an analyte binder attached to a reference binder, extracting a calibration curve from binding a reference material to the reference binder, and calibrating the nanosensor by using the calibration curve to correct for device variation. In another embodiment, the analyte binder comprises a polynucleotide, polypeptide, aptamer and/or antibody. In another embodiment, the nanosensor comprises a nanowire based field effect transistor (FET). In another embodiment, the reference binder comprises a polynucleotide, polypeptide, aptamer and/or antibody. In another embodiment, the binding of the reference material to the reference binder is at a high affinity and/or highly selective. In another embodiment, the reference binder comprises biotin. In another embodiment, the reference material comprises avidin.

Other embodiments include a nanosensor array, comprising one or more analyte binders and reference binders operatively linked to a nanosensor. In another embodiment, the one or more analyte binders and reference binders are linked to the nanosensor in a fixed ratio. In another embodiment, the reference binders have a high affinity to a reference compound. In another embodiment, the nanosensor comprises a nanowire based field effect transistor (FET). In another embodiment, the nanosensor comprises a biosensor. In another embodiment, the one or more analyte binders have an affinity to a biomolecule, polynucleotide, polypeptide, aptamer and/or antibody.

Other features and advantages of the invention will become apparent from the following detailed description, taken in conjunction with the accompanying drawings, which illustrate, by way of example, various embodiments of the invention.

### BRIEF DESCRIPTION OF THE DRAWINGS

Exemplary embodiments are illustrated in referenced figures. It is intended that the embodiments and figures disclosed herein are to be considered illustrative rather than restrictive.

FIG. 1 depicts, in accordance with an embodiment described herein, a schematic drawing demonstrating how calibration of a nanosensor may be implemented.

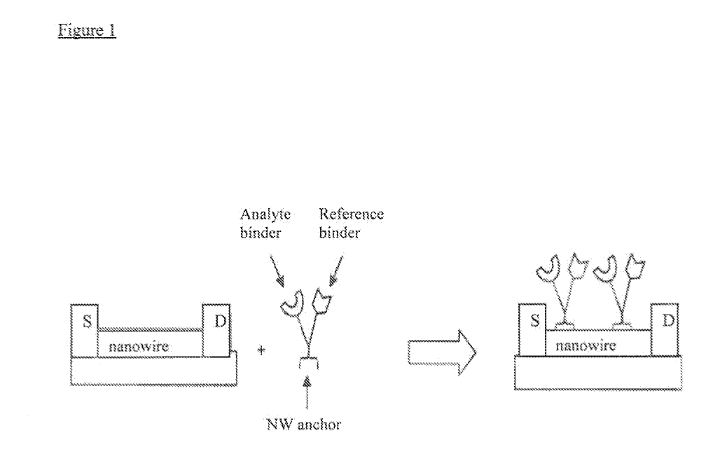

FIG. 2 depicts, in accordance with an embodiment described herein, an example of how calibration of a nanosensor may be implemented. Each of the sensors in the array is sensitive to the lack wedge shaped object. However, device A, B and C each detect different analyte. Thus, although there may be a different pair of analyte binder and analyte for each device, there is a common pair of reference binder and reference compound for each device, allowing calibration of the nanosensor.

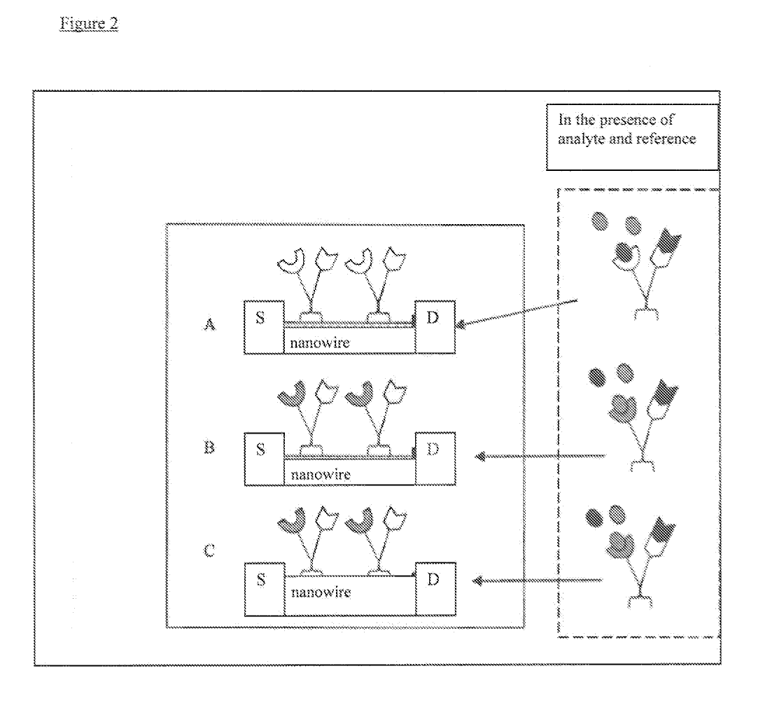

### DETAILED DESCRIPTION

All references cited herein are incorporated by reference in their entirety as though fully set forth. Unless defined otherwise, technical and scientific terms used herein have the same meaning as commonly understood by one of ordinary skill in the art to which this invention belongs. Singleton et al., Dictionary of Microbiology and Molecular Biology 3rd ed., J. Wiley & Sons (New York, N.Y. 2001); March, Advanced Organic Chemistry Reactions, Mechanisms and Structure 5th ed., J. Wiley & Sons (New York, N.Y. 2001); and Sambrook and Russel, Molecular Cloning: A Laboratory Manual 3rd ed., Cold Spring Harbor Laboratory Press (Cold Spring Harbor, N.Y. 2001), provide one skilled in the art with a general guide to many of the terms used in the present application.

One skilled in the art will recognize many methods and materials similar or equivalent to those described herein, which could be used in the practice of the present invention. Indeed, the present invention is in no way limited to the methods and materials described. For purposes of the present invention, the following terms are defined below.

As used herein, “FET” means field effect transistor.

As used herein, “NW” means nanowire.

As used herein, “aptamers” are molecules that may bind to a target molecule with specificity.

As used herein, an “analyte binder,” or probe, is any material that may be used as to bind an analyte and/or compound of interest. Similarly, a “reference binder,” or secondary binding agent, is any material that may be used to bind a reference compound and/or reference material so that devices in an array may be calibrated to a common state.

As disclosed herein, the inventors have calibrated the devices in a nanosensor array by using a secondary binding agent. Each unit bound to a nanowire surface may have a probe, or analyte binder, that will bind to a desired analyte, and a secondary agent, or reference binder that will bind a reference compound. Thus, the sensor will respond to two different materials: the desired analyte and a reference compound. In this way, the entire array may be calibrated with a single solution of the reference material and correct for device to device variation. Detailed calibration curves for both the reference and analyte solutions with single devices can then be used to give accurate response functions for each of the devices in the array.

In one embodiment, the present invention provides a method of preparing a nanosensor for calibration by attaching an analyte binder to a reference binder. In another embodiment, the analyte binder and the reference binder are in a fixed ratio of each other. In another embodiment, the analyte binder is a polynucleotide, polypeptide, aptamer and/or antibody. In another embodiment, the nanosensor includes a nanowire based field effect transistor. In another embodiment, the nanosensor includes a multiplexed bionanosensor array.

In one embodiment, the present invention provides a method of calibrating a nanosensor by generating a calibration curve from a common reference solution and calibrating the nanosensor by comparing individual devices in the nanosensor to the calibration curve.

In one embodiment, the present invention provides a nanosensor comprising a unit bound to both an analyte binder, capable of binding an analyte of interest, and a reference binder, capable of binding a reference compound. In another embodiment, the reference binder includes biotin and the reference compound includes avidin. In another embodiment, the reference binder and the reference compound bind at high selectivity and/or affinity.

In one embodiment, the present invention provides an array with a plurality of sensors, where each sensor is sensitive to both an analyte signal and a reference signal.

Other features and advantages of the invention will become apparent from the following detailed description, which illustrate, by way of example, various features of embodiments of the invention.

### EXAMPLES

The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

### Example 1

### General Makeup of a Sensor Array

The sensing element in the arrays may be a nanowire based field effect transistor (FET). FETs of this type are very sensitive to their environment. Since the semiconducting material in the channel of the FET is a nanowire (NW), small changes in the environment around the NW, such as temperature, pressure, ionic strength for solutions in contact with the wire, etc., lead to marked changes in the conductance of the NW and thus the performance of the FET. NW based FETs have been prepared with carbon nanotubes and a range of NW materials, such as Si, In₂O₃ and others. These devices have been used as chemical sensors for both gaseous and solution samples. While these FETs are sensitive to their environment, they are not selective for a specific analyte. In order to generate a biosensor, the surface of the nanowire is coated with a molecule or biomaterial that selectively binds a desired analyte. This binding agent will selectively bind the analyte of choice to the NW, making the sensor selective for the desired biomaterial. Thus, nanobiosensors may be prepared for detecting any number of proteins, oligonucleotides, biomolecules, etc.

### Example 2

### Preparing a Multiplexed Array

To prepare a multiplexed array capable of detecting several biomolecules simultaneously, different devices must be coated with different binding agents. The agents may be, for example, oligonucleotides, antibodies, aptamers, or any other material that will bind the target analyte with high affinity and high specificity. Thus, if an array of ten devices is prepared and each coated with a different binding agent, this array could be used to measure the levels of ten different biomaterials at once. If the ten devices are placed close together on the substrate, this array can be coupled with a microfluidic delivery system and used to analyze very small samples, very rapidly. Thus, multiplexed sensor arrays may be produced that are capable of measuring a large number of biomaterials (potentially 100's or 1000's) in a single sample.

### Example 3

### Preparing an FET Array

The FET array may be prepared by synthesizing NW materials in bulk, depositing them uniformly on the substrate and add source and drain electrodes on top of the substrate coated with NWs. This method requires that the NWs be uniformly dispersed over the surface, so that each pair of source and drain electrodes have a similar number of NWs in the channel. There will be some variation, since the NWs are randomly oriented over the surface. Adjusting the NW density on the surface and the source-drain structure, it is possible to make arrays where all of the devices have 10's of NWs in the channel. This variation in NW number between devices leads to device arrays that give channel conductance values within a factor of ten of each other. This was demonstrated for an array of 24 devices.

### Example 4

### Converting an Array of FETs to a Multiplexed Array of Nanobiosensors

Analyte binding groups may be anchored to the NW surface, converting an array of FETs into a multiplexed array of biosensors. This is expected to cause a divergence in the properties of the devices within the array. Each bonding group is different and may lead to different amounts of the recognition agent being bound to each NW within the array. A given binding agent may bind at the same density in a given FET, but each different binding agent may be loaded at a different density in the array. Thus, while the individual FET will have a narrow range of device properties, the sensing ability of the different sensors is expected to vary across the array, due to different binding affinities of the various recognition agents, as well as different densities of the various recognition agents at the nanowire surfaces of the individual sensors within the array.

### Example 5

### Calibration of Devices using Secondary Binding Agent

The solution to the variation in sensing ability for each of the analytes may be solved by generating calibration curves. Each device is calibrated against a number of solutions of the analyte at known concentrations. This will simultaneously correct for variations in the FET properties and the loading levels of the binding agent between devices. However, this approach may not be practical for a device to be used in a clinical setting, especially in light of the large time and expense of calibrating each sensor in an array immediately prior to use. The calibration is very important to determine the sensitivity and responsivity of the device, but such a calibration cannot be easily carried out on every device that is used.

The inventors solve this problem by using a secondary binding agent whose function is to calibrate the devices in the array to a common state. Each unit bound to the NW surface may consist of an oligonucleotide, protein or other material that will recognize the desired analyte, and a second agent that will bind a reference compound. In this way, the sensor will respond to two different materials: the desired analyte and a reference compound. The binding of the reference compound will preferably be highly selective and bind at high affinity. An example of a reference pair is biotin-avidin. Such a dual functional surface coating is illustrated herein. If the same reference binding agent is used for all of the devices within the array, an array is formed in which each sensor detects a different biomolecule, but at the same time, the devices are all sensitive to common biomaterial. Thus, the entire array may be calibrated with a single solution of the reference material and corrected for device to device variation.

Detailed calibration curves for both the reference and analyte solutions with single devices can then be used to give accurate response functions for each of the devices in the array. Note that the calibration of the multiplexed array does not involve solutions of the desired analyte, but only the reference compound. Calibration with the analyte is carried out, but on an isolated device and only used to generate an analyte specific calibration curve, which is in turn used to correct devices within the array (after the number of recognition agents in the device has been determined with the reference measurement). Calibration with the reference solution is expected to be rapid and accurate. It will also be an inexpensive method, as the reference compound can be an abundant material, whose standard solutions will be stable and inexpensive. By binding every analyte binder with a reference binder in a fixed ratio (such as shown herein as 1:1), the reference signal accurately reflects the amount of the recognition agent on the FET surface and thus provides the basis for correlating the electrical response of the sensor to the analyte concentration in contact with the sensor based on a previously determined calibration curve.

One skilled in the art will recognize many methods and materials similar or equivalent to those described herein, which could be used in the practice of the present invention. Indeed, the present invention is in no way limited to the methods and materials described. For purposes of the present invention, the following terms are defined below.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

1. A method of calibrating an analyte response of a nanosensor, comprising:
providing a nanosensor comprising a quantity of an analyte binder and a quantity of a reference binder in a fixed ratio to one another;
calibrating the analyte response of the nanosensor by binding a reference material to a portion of the quantity of the reference binder.

2. The method of claim 1, wherein the analyte binder comprises a biomolecule, polynucleotide, polypeptide, aptamer and/or antibody.

3. The method of claim 1, wherein the nanosensor comprises a nanowire based field effect transistor (FET).

4. The method of claim 1, wherein the reference binder comprises a biomolecule, polynucleotide, polypeptide, aptamer and/or antibody.

5. The method of claim 1, wherein the binding of the reference material to the portion of the quantity of the reference binder is at a high affinity and/or is highly selective.

6. The method of claim 1, wherein the reference binder comprises biotin.

7. The method of claim 1, wherein the reference material comprises avidin.

8. A nanosensor array, comprising:
a nanosensor; and
one or more analyte binders and a plurality of reference binders operatively linked to the nanosensor.

9. The nanosensor array of claim 8, wherein the one or more analyte binders and the plurality of reference binders are in a fixed ratio.

10. The nanosensor array of claim 8, wherein the plurality of reference binders have high affinity for a reference compound.

11. The nanosensor array of claim 8, wherein the nanosensor comprises a nanowire based field effect transistor (FET).

12. The nanosensor array of claim 8, wherein the nanosensor comprises a biosensor.

13. The nanosensor array of claim 8, wherein the one or more analyte binders have an affinity to a biomolecule, polynucleotide, polypeptide, aptamer and/or antibody.

14. A method of calibrating a nanosensor, comprising:
providing a nanosensor comprising an analyte binder attached to a reference binder;
extracting a calibration curve through a process that comprises binding a reference material to the reference binder; and
calibrating the nanosensor by using the calibration curve to correct for device variation.

15. The method of claim 14, wherein the analyte binder comprises a biomolecule, polynucleotide, polypeptide, aptamer and/or antibody.

16. The method of claim 14, wherein the nanosensor comprises a nanowire based field effect transistor (FET).

17. The method of claim 14, wherein the reference binder comprises a biomolecule, polynucleotide, polypeptide, aptamer and/or antibody.

18. The method of claim 14, wherein the binding of the reference material to the reference binder is at a high affinity and/or is highly selective.

19. The method of claim 14, wherein the reference binder comprises biotin.

20. The method of claim 14, wherein the reference material comprises avidin.
